(19) United States
(12) Patent Application Publication
(10) Pub. No.: US 2026/0067341 A1
(43) Pub. Date: Mar. 5, 2026

(54) SYNCHRONOUS CROSS-EXPERIENCE PARTY-BASED ENGAGEMENT

(71) Applicant: Roblox Corporation, San Mateo, CA (US)

(72) Inventors: Thariq RIDHA, San Mateo, CA (US); Kirsten KOA, San Mateo, CA (US); Joshua LI, San Jose, CA (US); Lukasz ZATORSKI, Sunnyvale, CA (US); Joseph REESE, San Mateo, CA (US); Charlie LIU, San Mateo, CA (US)

(73) Assignee: Roblox Corporation, San Mateo, CA (US)

(21) Appl. No.: 19/319,052

(22) Filed: Sep. 4, 2025

Related U.S. Application Data
(60) Provisional application No. 63/691,280, filed on Sep. 5, 2024.

(51) Int. Cl. H04L 65/1096; H04L 65/1069; H04L 65/1093; H04M 1/72427; H04M 1/72436; H04M 3/58

(52) U.S. Cl. CPC H04L 65/1096; H04L 65/1069; H04L 65/1093; H04M 1/72427; H04M 1/72436; H04M 3/58

(57) ABSTRACT

Some implementations include methods, systems and computer-readable media for party-based engagement across virtual experiences. Such methods include causing users in a group of users to join a first virtual experience, forming a party connection using a party connection management data structure, providing the users in the group of users with a first interface that enables the users to interact in the first virtual experience, and transitioning from the first virtual experience to a second virtual experience by using the party connection management data structure to maintain the party connection by forming communication sessions between the client devices of the users with a server that hosts a particular instance of the second virtual experience, wherein maintaining the party connection between the users in the group of users during the transitioning comprises performing the transition to so that that the users are placed in the particular instance of the second virtual experience.

### CROSS-REFERENCE TO RELATED APPLICATIONS

This application claims priority under 35 U.S.C. § 119(e) to U.S. Provisional Patent Application No. 63/691,280 , entitled “SYNCHRONOUS CROSS-EXPERIENCE PARTY-BASED ENGAGEMENT,” filed on Sep. 5, 2024, the content of which is incorporated herein in its entirety.

### TECHNICAL FIELD

Implementations relate generally but not exclusively to virtual experiences. More specifically, implementations relate to methods, systems, and computer-readable media to enable synchronous party-based engagement of users across multiple virtual experiences on a platform.

### BACKGROUND

In the current state of virtual platforms (also referred to herein as virtual environments), users frequently engage in various multiuser virtual experiences, such as in a multiplayer game. Such users may often want to collaborate and interact with groups of friends or other groups in real-time or near-real-time. Many platforms provide options for users to join multiuser virtual experiences. Maintaining a cohesive group of users across multiple virtual experiences presents significant challenges. While users may be able to join friends or another group of users in a specific game or other type of virtual experience, transitioning seamlessly between different experiences while keeping the group of users intact is often difficult or impossible. There are other shortcomings as well.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect, a computer-implemented method to enable synchronous party-based interaction across multiple virtual experiences, each virtual experience corresponding to an instance hosted by a server on a virtual experience platform, is provided, the computer-implemented method comprising: causing individual users in a group of two or more users to join a first virtual experience on the virtual experience platform by forming communication sessions between client devices of the individual users with a first server on the virtual experience platform that hosts a first instance of the first virtual experience; forming a party connection between the users in the group in the first virtual experience by using a party connection management data structure; providing the users in the group with a first interface that enables the users to collaboratively interact in the first virtual experience via the party connection; and transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience, wherein the virtual experience platform hosts multiple instances of the second virtual experience and wherein maintaining the party connection between the users in the group during transitioning comprises performing the transition so that the users are placed in the particular instance of the second virtual experience.

Various implementations of the computer-implemented method are described herein.

In some implementations, transitioning further comprises moving user avatar information associated with the individual users in the group from the first instance of the first virtual experience to the particular instance of the second virtual experience.

In some implementations, forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

In some implementations, transitioning is performed in response to at least one user in the group providing a command to cause the group to join the second virtual experience.

In some implementations, the computer-implemented method further comprises: tracking accomplishments of the users in the group in the first virtual experience; storing the accomplishments in the party connection management data structure; and migrating the accomplishments of the users in the group into the second virtual experience by using the party connection management data structure during transitioning.

In some implementations, the computer-implemented method further comprises maintaining a communication channel to provide seamless and continuous communication among the users in the group during the collaborative interaction of the users in the first instance of the first virtual experience and during collaborative interaction of the users in the particular instance of the second virtual experience.

In some implementations, the seamless and continuous communication persists upon one or more individual users of the group leaving one of the first instance of the first virtual experience or the particular instance of the second virtual experience and rejoining the group in the first or the second virtual experience.

In some implementations, the seamless and continuous communication among the users in the group includes voice communication using a voice communication channel that persists throughout transitioning from the first virtual experience to the second virtual experience.

In some implementations, the seamless and continuous communication among the users in the group includes text-based communication using a text communication channel that persists throughout transitioning from the first virtual experience to the second virtual experience.

In some implementations, the computer-implemented method further comprises: performing automatic selection of a next virtual experience as the second virtual experience based on one or more group preferences, one or more platform recommendations, or a combination thereof, wherein transitioning is initiated based on the automatic selection.

In some implementations, the second server that hosts the particular instance of the second virtual experience is same as the first server that hosts the first instance of the first virtual experience.

According to another aspect, non-transitory computer-readable medium is provided. The non-transitory computer-readable medium has instructions stored thereon that, responsive to execution by a processing device, cause the processing device to perform or control performance of operations to enable synchronous party-based interaction across multiple virtual experiences, each virtual experience corresponding to an instance hosted by a server on a virtual experience platform. The operations comprise: causing individual users in a group of two or more users to join a first virtual experience on the virtual experience platform by forming communication sessions between client devices of the individual users with a first server on the virtual experience platform that hosts a first instance of the first virtual experience; forming a party connection between the users in the group in the first virtual experience by using a party connection management data structure; providing the users in the group with a first interface that enables the users to collaboratively interact in the first virtual experience via the party connection; and transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience, wherein the virtual experience platform hosts multiple instances of the second virtual experience and wherein maintaining the party connection between the users in the group during transitioning comprises performing the transition so that the users are placed in the particular instance of the second virtual experience.

Various implementations of the non-transitory computer-readable medium are described herein.

In some implementations, transitioning further comprises moving user avatar information associated with the individual users in the group from the first instance of the first virtual experience to the particular instance of the second virtual experience.

In some implementations, forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

In some implementations, transitioning is performed in response to at least one user in the group providing a command to cause the group to join the second virtual experience.

In some implementations, the operations further comprise maintaining a communication channel to provide seamless and continuous communication among the users in the group during the collaborative interaction of the users in the first instance of the first virtual experience and during collaborative interaction of the users in the particular instance of the second virtual experience.

According to another aspect, a system is disclosed, comprising: a memory with instructions stored thereon; and a processing device, coupled to the memory, the processing device configured to access the memory, wherein the instructions when executed by the processing device cause the processing device to perform or control performance of operations to enable synchronous party-based interaction across multiple virtual experiences, each virtual experience corresponding to an instance hosted by a server on a virtual experience platform, comprising: causing individual users in a group of two or more users to join a first virtual experience on the virtual experience platform by forming communication sessions between client devices of the individual users with a first server on the virtual experience platform that hosts a first instance of the first virtual experience; forming a party connection between the users in the group in the first virtual experience by using a party connection management data structure; providing the users in the group with a first interface that enables the users to collaboratively interact in the first virtual experience via the party connection; and transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience, wherein the virtual experience platform hosts multiple instances of the second virtual experience and wherein maintaining the party connection between the users in the group during transitioning comprises performing the transition so that the users are placed in the particular instance of the second virtual experience.

Various implementations of the system are described herein.

In some implementations, transitioning further comprises moving user avatar information associated with the individual users in the group from the first instance of the first virtual experience to the particular instance of the second virtual experience.

In some implementations, forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

In some implementations, the operations further comprise maintaining a communication channel to provide seamless and continuous communication among the users in the group during the collaborative interaction of the users in the first instance of the first virtual experience and during collaborative interaction of the users in the particular instance of the second virtual experience.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture for enabling synchronous party-based engagement across multiple virtual experiences on a platform, in accordance with some implementations.

FIG. 2 is a flow diagram illustrating a pipeline for enabling synchronous party-based engagement across multiple virtual experiences on a platform, in accordance with some implementations.

FIG. 3 is a diagram illustrating an example of an invitation to join a party and an acceptance of the invitation, in accordance with some implementations.

FIG. 4 is a diagram illustrating an example of a user interface for party-based communication on a platform, in accordance with some implementations.

FIG. 5 is a diagram illustrating an example of a user interface for party-based engagement on a platform, in accordance with some implementations.

FIG. 6 is a diagram illustrating an example of party-based collaborative engagement within a virtual experience, in accordance with some implementations.

FIG. 7 is a flowchart illustrating aspects of forming a party of users in a first virtual experience and transitioning the party to a second virtual experience, in accordance with some implementations.

FIG. 8 is a flowchart illustrating aspects of transitioning a party from a first virtual experience to a second virtual experience, in accordance with some implementations.

FIG. 9 is a flowchart illustrating aspects of tracking, storing, and migrating user accomplishments from a first virtual experience to a second virtual experience, in accordance with some implementations.

FIG. 10 is a flowchart illustrating aspects of maintaining a communication channel, in accordance with some implementations.

FIG. 11 is a flowchart illustrating aspects of permitting a user to leave and rejoin a group, in accordance with some implementations.

FIG. 12 is a diagram illustrating an example virtual experience platform hosting instances of virtual experiences at corresponding server(s) and transitioning between virtual experiences, in accordance with some implementations.

FIG. 13 is a diagram illustrating aspects of formation of a party and transitioning the party from a first virtual experience to a second virtual experience, in accordance with some implementations.

FIG. 14 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Existing systems often treat each experience (e.g., a game session) as an isolated interaction. When users wish to transition to a new experience, the users often have to manually rejoin the users' friends or re-establish the group of users in the new experience. This process can be cumbersome, as the process involves users leaving one experience, coordinating the selection of another experience, and ensuring that each member of the group joins the same instance of the new experience.

Further, the group may have to be re-established in the new experience once all of the users are again present in the new experience. The lack of a persistent, cross-experience group management system disrupts the continuity of group engagement. Such disrupted continuity may lead to frequent disconnects and frustration, especially when users are placed in different instances or servers.

Another shortcoming of current solutions for managing interactions for groups of users is the lack of seamless communication between users in a group of users across experiences. Communication between such users, whether through text, voice, or a combination of such modalities, is often limited to communication between users in individual experiences.

When users transition between experiences, the users often lose the ability to communicate with each other. Losing the ability to communicate forces the users in the group to rely on external communication tools or other alternative communication tools or to manually reconnect in each new experience. This fragmentation with respect to communication between users in a group of users undermines the collaborative and social nature of virtual environments. Communication is one aspect of maintaining engagement and interaction among users in a group of users.

Furthermore, many existing platforms lack or have insufficient automatic mechanisms to ensure that users in a group of users remain together throughout their virtual interactions. If one user from a group of users transitions to a new experience, other users in the group of users may be left behind. Such a situation may lead to inconsistent and fragmented group interactions.

These shortcomings make it difficult for users to maintain a sense of continuity and cohesion as the users navigate through different experiences on a virtual platform. As virtual environments continue to grow in scale and complexity, these issues become increasingly prominent, reducing the overall quality of the user experience.

Thus, there is a need for a system that addresses the above and other shortcomings, which enables synchronous party-based engagement across multiple virtual experiences on a virtual platform. Such synchronous party-based engagement may permit groups of users to stay connected as a group as the users transition as a group between different experiences.

Such a system may maintain seamless communication and collaboration throughout. The seamless communication may ensure that users in the group do not have to manually rejoin the group or coordinate each transition. Additionally, various implementations may provide mechanisms to keep all group members in the same virtual instance of a given experience. This functionality may eliminate the fragmentation of the current systems and may enhance the overall user experience across diverse virtual environments, such as for users that want facilitated interaction with other users in a group.

The implementations presented herein enable synchronous party-based engagement across multiple virtual experiences on a virtual platform. A group of users may have a continuous connection between users in the group initiated and maintained on a virtual platform capable of hosting and maintaining a variety of virtual experiences. The connection is maintained between the users in the group while the users proceed with engaging in collaborative activities with one another across multiple different virtual experiences.

The aspects (e.g., features) provided by implementations help to ensure that the users in the group remain connected during transitions between experiences. Such features avoid or otherwise reduce the requirement for manual rejoining or manual coordination to maintain the group. Seamless communication through, for example, text chat, voice chat, or a combination of various chat modalities is maintained throughout. Such seamless communication may occur via a user interface for party-based group communications, the seamless communication enabling uninterrupted interaction between users and enhancing the overall collaborative experience for users.

In some implementations, the implementations synchronize the group of users across multiple server instances. Such synchronizing ensures that all of the users in a group stay together in the group in the same instance or server of a shared virtual experience during transitions.

This synchronizing prevents the common issue of group members being separated into different instances or servers when switching between experiences. By maintaining consistent and uninterrupted engagement for users in the group, the features improve the continuity and quality of group interactions on virtual platforms. The features provided by implementations thus result in more cohesive and enjoyable collaborative engagement and communication for users in a group.

### Problem

In virtual platforms capable of hosting and maintaining multiple virtual experiences, users who wish to engage in collaborative activities with friends or groups of other users face challenges in staying connected when transitioning as a group between different experiences. Existing virtual platforms often disconnect users in groups during these transitions or require the users in the group to manually rejoin the group. Such disconnection may lead to a fragmented and disruptive user experience. Furthermore, communication among group members with one another can be interrupted by such disconnection.

Such interrupted communication creates barriers to seamless and continuous collaborative engagement. These issues reduce the overall quality of the group experience for users, making it difficult for users to maintain cohesion across virtual environments.

### Solution

Various implementations discussed herein enable synchronous party-based engagement across multiple virtual experiences on a platform. Such implementations may address the benefit of seamless group connectivity. A persistent connection is established between a group of users and maintained as the users in the group transition between different experiences.

The persistent connection permits the users to collaborate without interruption. The communication between users remains continuous and seamless throughout, ensuring the group of users stays synchronized during transitions. This approach enhances user experiences by eliminating a requirement for manual rejoining or reconnection by users, providing smoother and more cohesive group engagement across the platform.

In some implementations, features are described the in the context of a game and related game functionality, and such is only an example, and the features described herein can be applied to other types of virtual experiences that may not necessarily involve games. This approach also establishes that users wish to interact together and various implementations allocate space in a server for members of the party.

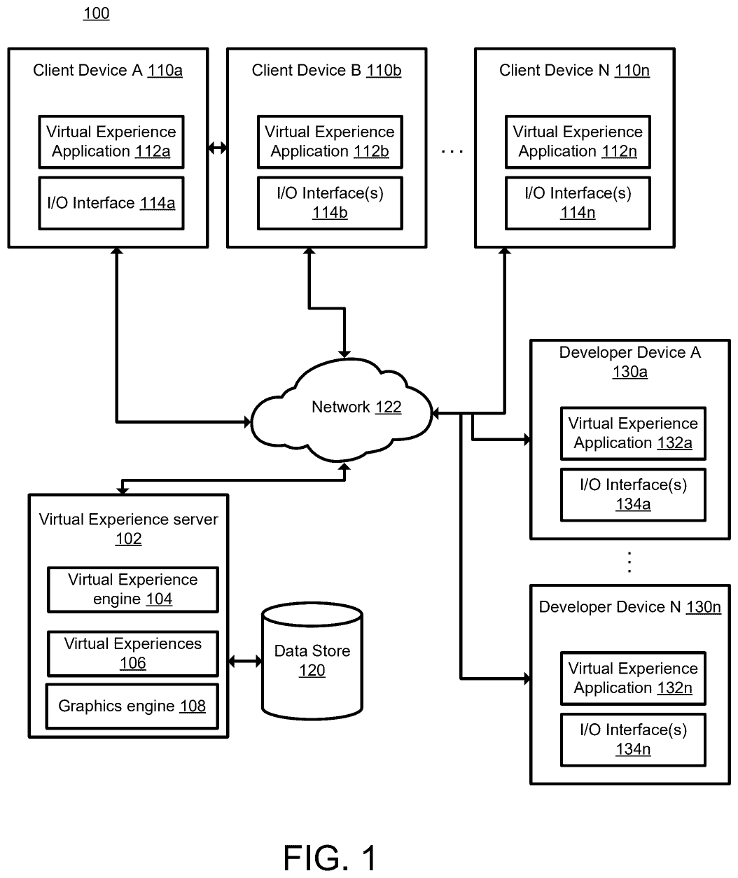

FIG. 1 is a diagram of an example system architecture for enabling synchronous party-based engagement across multiple virtual experiences on a platform, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

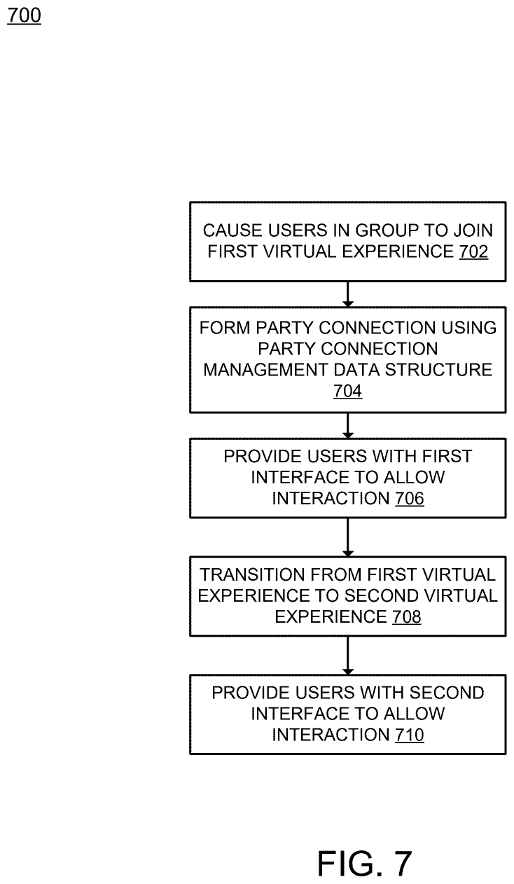

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 and/or some other device(s)/component(s) of FIG. 1 may perform one or more of the operations described below in connection with the flowcharts shown in FIGS. 7-11. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user. ” In some contexts, a “user” may be a system administrator or other entity that may have privileges, roles, etc. associated with the virtual experience server 102 and which may be different from or additional to those of end users, developers, or other types of users.

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102, hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, for example, dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users with access to simplified 3D virtual object models that are represented by a mesh of a low polygon count (e.g., between about 20 and about 30 polygons).

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device. ” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, application, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, or upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs) and thus is not limited to use in websites.

According to one aspect for enabling synchronous party-based engagement across multiple virtual experiences on a platform, a connection is initiated between a group of users on a platform. The overall connection may be implemented using individual connections for individual users in the group of users. The users in the group are permitted to collaboratively engage in a first virtual experience on the platform by using the connection. The connection between the users is maintained during a transition of the group of users from the first virtual experience to a second virtual experience.

The users in the group are enabled to collaboratively engage in the second virtual experience after the transition. Seamless and continuous communication is also facilitated among the users in the group throughout collaborative engagement by users in the group with the first virtual experience and the second virtual experience on the platform.

In some implementations, initiating the connection between the group of users includes generating a unique identifier for the group being generated. Such a unique identifier may facilitate reference to and tracking of the group. Because the identifier is unique, there is no ambiguity about which group of users the unique identifier is being used to specify.

In some implementations, maintaining the connection between the users in the group during the transition includes synchronizing the users to ensure the users are placed in the same instance of the second virtual experience. When the users are in together in the same instance of the second virtual experience, this synchronizing facilitates management of the group of users and communication between users in the group, because many platforms are designed such that interaction between users is achievable when the users are, in addition to being in the same virtual experience, in the same instance of the given virtual experience.

In some implementations, the transition from the first virtual experience to the second virtual experience occurs in response to a user in the group proposing a selection of the second virtual experience. Such a proposal may be made by a single user in the group. The user making the proposal may require certain permissions to do so. For example, some users in the group may have privileges that entitle those users to propose a change from the first virtual experience to the second virtual experience.

In some implementations, progress and accomplishments of the users in the group are tracked during the engagement of the users with the first and second virtual experiences. Tracking progress and accomplishments in this matter may provide information about how to coordinate group transitions between the distinct experiences, as well as how to facilitate communication between users in the group, including before, during, and after the transition.

In some implementations, the seamless and continuous communication among the users in the group includes voice communication that persists throughout the transition between the first and second virtual experiences. Each client may maintain the connection to a voice channel when connected to a party. This channel exists as long as the user is in the party. There is a method to do voice communication within an experience. However, this approach is not limited to the party members and is public. Leaving the experience means that a user can no longer use the voice in that experience. Other approaches to managing the transition are possible. Once the transition is complete, the communications channel may be hosted by the second virtual experience.

In some implementations, the seamless and continuous communication among the users in the group includes text-based communication that persists throughout the transition between the first and second virtual experiences. Each client may maintain the connection to a text channel when connected to a party. This channel exists as long as the user is in the party. There is a method to do text communication within an experience. However, this approach is not limited to the party members and is public. Leaving the experience means that a user can no longer use the text in that experience. Once the transition is complete, the communications channel may be hosted or otherwise supported by the second virtual experience.

While the above discussion describes the communications channel as being one of voice communication or text communication, the communications channel may include both of these approaches for communication. Additionally, other types of communication are possible. For example, the users in the group may share images, videos, or other content including visual content.

Additionally, because the users are present as a group in the same virtual experiences (the first virtual experience and the second virtual experience), the users may communicate by taking actions with corresponding avatars to communicate with one another. For example, a user may cause a corresponding avatar to move its limbs in a given manner that communicates information.

For example, a first user may ask a second user (such as by using a voice channel or a text-based communications channel) a question such as “Where is the bank?” and the second user may provide the user with the answer to the question by causing an avatar to gesture towards the bank in the virtual experience. Such visual communication within an experience may be facilitated because the users in the group begin in a first virtual experience (in a single instance) and transition to a second virtual experience (in a single instance). Because all of the users are initially and finally participating in the same instances, this facilitates the ability of the users to interact in the shared instances.

In some implementations, users in the group are permitted to invite additional users to join the group during the engagement of the users with the first or second virtual experiences. For example, at least one user in the group of users may provide a command to cause additional users to join the group of users in the second virtual experience.

In some implementations, the transition from the first virtual experience to the second virtual experience is initiated based on an automatic selection that selects the next virtual experience based on one or more group preferences or one or more platform recommendations. For example, such a group preference may include a list of next virtual experience from which the next virtual experience is selected. Such a platform recommendation may include information associated with the group of users that may guide the choice of the next virtual experience.

In some implementations, the seamless communication persists upon one or more individual users leaving one of the virtual experiences and rejoining the group at a later time. In such implementations, the user's departure is temporary, but there are other group members that remain together, and the user then rejoins the group.

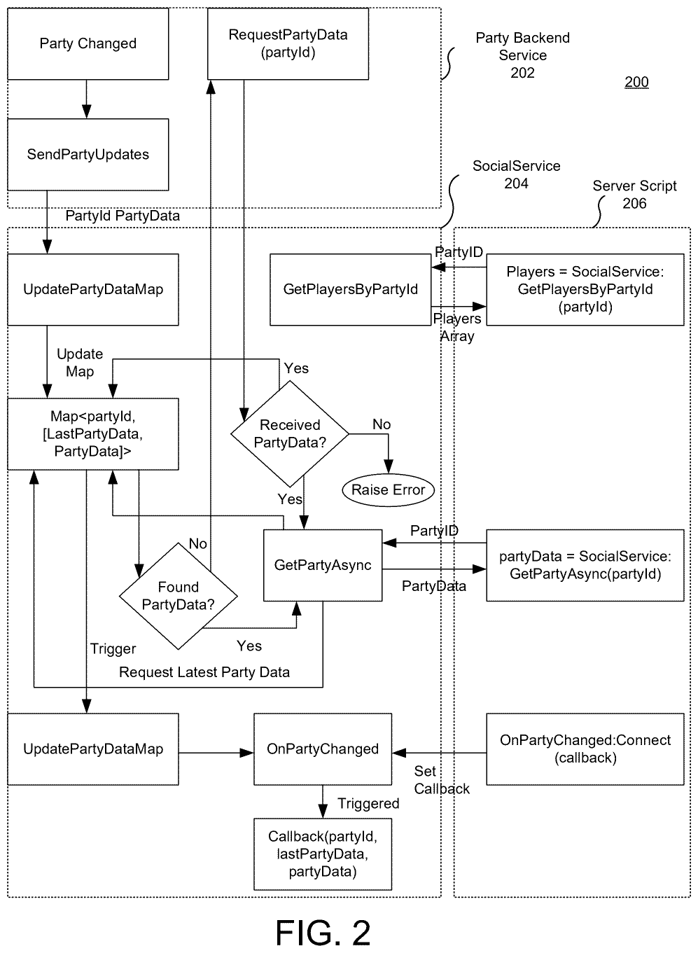

FIG. 2 is a flow diagram illustrating an example pipeline 200 for enabling synchronous party-based engagement across multiple virtual experiences on a platform, in accordance with some implementations. This example pipeline 200 includes several components that facilitate users in a party being kept synchronized across different virtual experiences while maintaining communication and coordination.

A Party Backend Service component 202 is responsible for managing the state and interactions of the users in a party. The backend service interacts with multiple components to track and maintain party data and ensure that users can collaborate across different virtual experiences. The Party Backend Service component 202 may provide a Party Changed event that triggers a SendPartyUpdates function call. The SendPartyUpdates function call provides PartyId PartyData to a SocialService component 204.

A SocialService component 204 provides functions such as GetPlayersByPartyId and GetPartyAsync. These functions permit the system to retrieve data about users in a party. The SocialService component 204 receives the PartyId PartyData, and uses such data to perform the function UpdatePartyDataMap, which updates the Map (where the Map includes <partyId, and [LastPartyData,PartyData]>). The SocialService component 204 shows decision points that assess whether the PartyData was found and/or received.

For example, if the PartyData was found or received, the GetPartyAsync function could be called. If the PartyData was not found, there could be another call to RequestPartyData. If the PartyData was not received, there could be an error. Once the PartyData is successfully received, the PartyData may be used to call UpdatePartyDataMap, which triggers an OnPartyChanged event.

The Server Script component 206 interacts with the SocialService component 204 to manage party-specific data. The function GetPlayersByPartyId in the SocialService component 204 retrieves a list of all players currently in a party within a specific server. In various implementations, this is accomplished by either looping through player instances in the server to identify those with the same PartyId, or by querying party data from a data map and using that data to retrieve individual player instances. Both approaches ensure that information regarding which players belong to the same party is available at the server and for group activities to be managed accordingly.

Once the party data is retrieved, the system can track changes in the state of the party using the OnPartyChanged event. This event is triggered whenever there is a change in the party's composition or activity, such as users joining or leaving the group or transitioning between virtual experiences. The system triggers the OnPartyChanged event with relevant parameters, including the PartyId, the last known party data, and the updated party data.

A callback function (which may be provided by the Server Script component 206 to the SocialService component 204) is set to handle the changes, permitting real-time or near-real-time synchronization of party members. Thus, the SocialService component 204 uses the GetPlayersByPartyId function to provide a Players Array to the Server Script component 206, such that the Server Script component 206 returns a PartyID using the function call Players=SocialService: GetPlayersByPartyId (partyId).

The next part of the flow involves the PartyDataMap, which maintains a record of the party's state. This data map stores both the previous state (LastPartyData) and the current state (PartyData) for each party. Whenever a change occurs, the PartyDataMap is updated (using UpdatePartyDataMap) with data to reflect a current composition and activity of the party. This permits the system to continually track the party's transitions between different virtual experiences on the platform.

If a request for party data is received, the GetPartyAsync method is utilized to fetch party information from the PartyDataMap. This fetching also ensures that all server instances handling the party members have access to up-to-date data. The flow also includes an error-handling mechanism, whereby, if no updated party data is found, an error is raised by the system.

Party updates are sent to all relevant server instances. The party updates are utilized to maintain synchronization across multiple servers, especially when users in a party are engaged in different virtual experiences or transitioning between different virtual experiences. Updates are sent via the SendPartyUpdates mechanism, and the PartyDataMap is continually updated to ensure consistency across all instances.

The pipeline as presented in FIG. 2 illustrates a flow that manages party-based engagement across multiple virtual experiences. The combination of the Party Backend Service component 202, SocialService component 204, Server Script component 206, PartyDataMap, event-handling processes, etc. facilitates users in a party remaining synchronized, transitions of the users being seamless, and engagement of the users being uninterrupted as users move across various virtual environments.

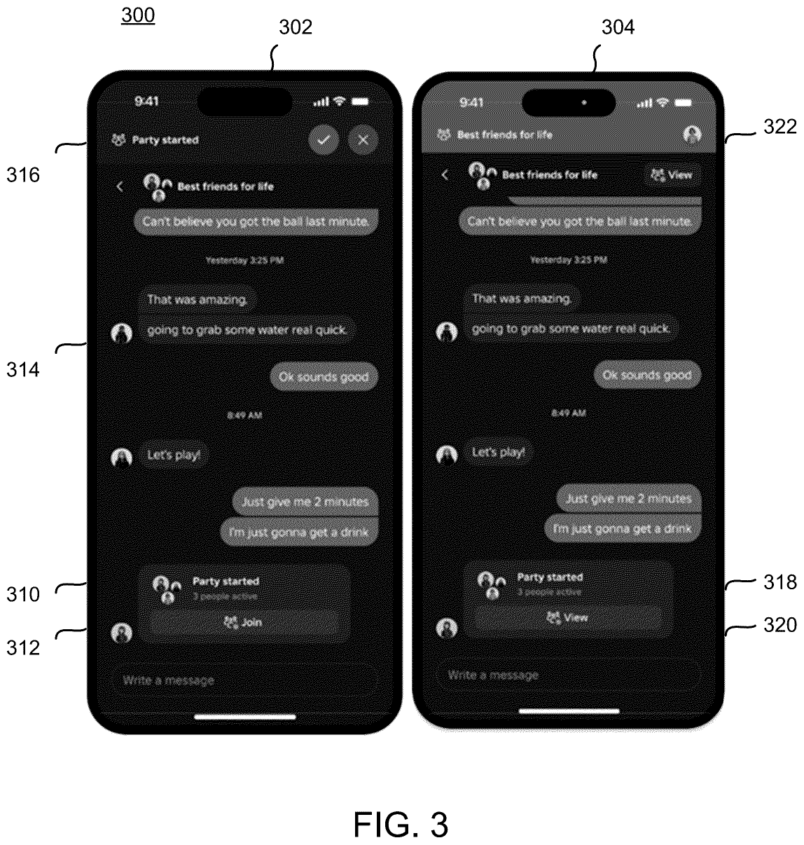

FIG. 3 is a diagram illustrating an example 300 of an invitation to join a party and an acceptance of the invitation, in accordance with some implementations. The figure shows two example user interface screenshots on mobile devices, illustrating how a user can interact with a party-based engagement system.

In the first screenshot 302, the user is presented with a notification indicating that a party has started. This notification is represented by a banner 310 at the bottom of the chat interface that reads “Party started” and “3 people active” alongside a join button 312. This banner 310 indicates that a group of users has already initiated a party and are actively engaging in a collaborative virtual experience (which may be a same instance of a first virtual experience). The user has the option to join the party by clicking the join button 312.

Above the party invitation, the chat history 314 reflects previous messages exchanged between the users in the group, demonstrating that the users were preparing to engage in a shared experience. The party invitation is prominently displayed at the top of the user interface 316, with a checkmark for acceptance and an X for dismissing the invitation, giving the user control over whether to participate in the party interaction.

In the second screenshot 304, after the user has accepted the invitation by selecting the join button 312, the interface updates to reflect that the user has now successfully joined the party. The banner 318 at the bottom now illustrates the text “Party started” and “3 people active” (that is, a group of people are actively engaging in a party voice chat or other collaborative virtual experience). The banner 318 is located alongside a “View” button 320, replacing the previous “Join” button 312. This banner 318 indicates that the user in the second screenshot 304 is currently part of the active party. The “View” button 320 permits the user to navigate to the party view.

In the party view, the user can observe real-time updates about matters relevant to the party and engage in communication with other party members. The chat interface may remain visible, permitting continued text-based communication among the users in the group. Use of a chat interface in this manner provides seamless integration between party engagement and messaging functionality. The party invitation at the top of the user interface has been replaced with a party banner 322 illustrating the name of the party, “Best friends for life. ” The name of the party may act as a unique identifier. The party may also be identified by another unique identifier (for example, a number in decimal, hexadecimal, or octal or an alphanumerical string). Additional aspects of generating such unique identifiers are discussed herein.

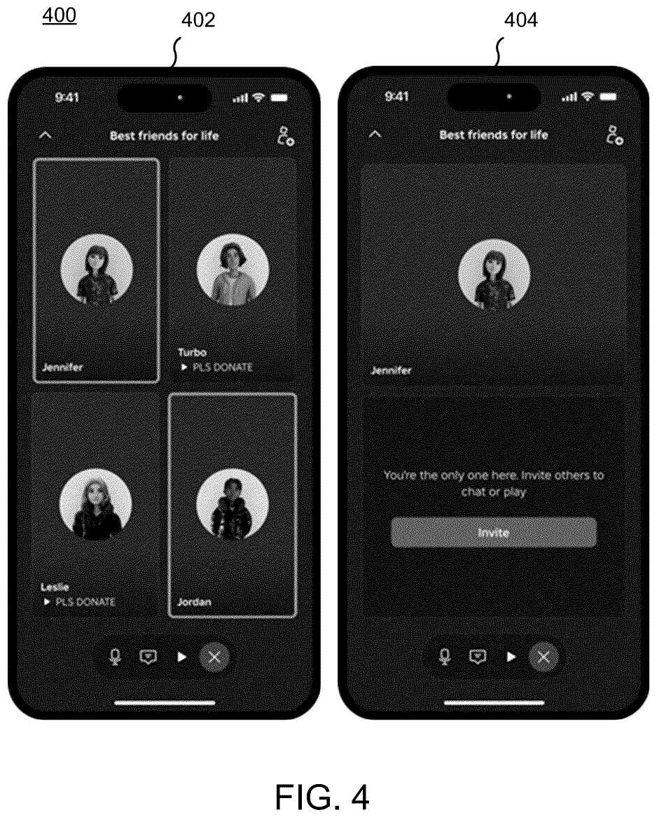

FIG. 4 is a diagram illustrating an example 400 of a user interface for party-based communication on a platform, in accordance with some implementations. FIG. 4 includes two user interface screenshots (first screenshot 402 and second screenshot 404) on mobile devices, highlighting different views of a party environment (that is, a “party view”), where users can engage in real-time voice communication.

In the first screenshot 402, the party view displays four active participants: Jennifer, Turbo, Leslie, and Jordan. Each participant is represented by an avatar tile, including a graphic of the user's avatar above the name of the participant.

The users who are actively speaking or engaged in the voice communication are highlighted with a bright outline around such users'avatars. This visual feedback indicates who is currently contributing to the voice chat, providing an intuitive way for users to see who is active in the conversation, and other forms of visual feedback may be used to convey such information.

While not illustrated in FIG. 4, there may be a microphone icon or another indicator next to each participant's name, illustrating that voice communication is enabled for that participant. At the bottom of the interface, users have access to several controls, including a microphone toggle for muting/unmuting a user's own voice, a button to open the text chat, and an exit button (illustrated with an “X”) to leave the party. The layout (as illustrated in FIG. 4) is designed to facilitate easy management of voice communication while permitting users to remain aware of who is actively speaking in the party.

In the second screenshot 404, the party view displays a single participant, Jennifer. The second screenshot 404 also illustrates the graphic of Jennifer's avatar above her name. The message below Jennifer's avatar indicates, “You're the only one here. Invite others to chat or play,” highlighting that no other users are currently in the party with Jennifer. A prominent “Invite” button is provided beneath the message.

This button may permit the user (in this case, Jennifer) to send invitations to other users to join the party. The invitations may be sent in various ways. For example, the invitations may involve internal messaging capabilities provided by the virtual experience platform. The invitations may also take the form of other messaging, such as e-mails, SMS (secure message service), text messages, and so on.

The absence of other participants in this view simplifies the interface, making it clear that the user can invite others to engage in communication or collaborative activities. The same control buttons for voice and chat appear at the bottom of the screen in the second screenshot 404, giving the user the option to manage voice chat settings or leave the party.

For example, the user may transition from operating based on the first screenshots to provide a view illustrating (such as in tiled form) the various users in the party, while the second screenshot 404 helps individual users take relevant actions, such as inviting other users and managing individual aspects of user interaction with the party communication session.

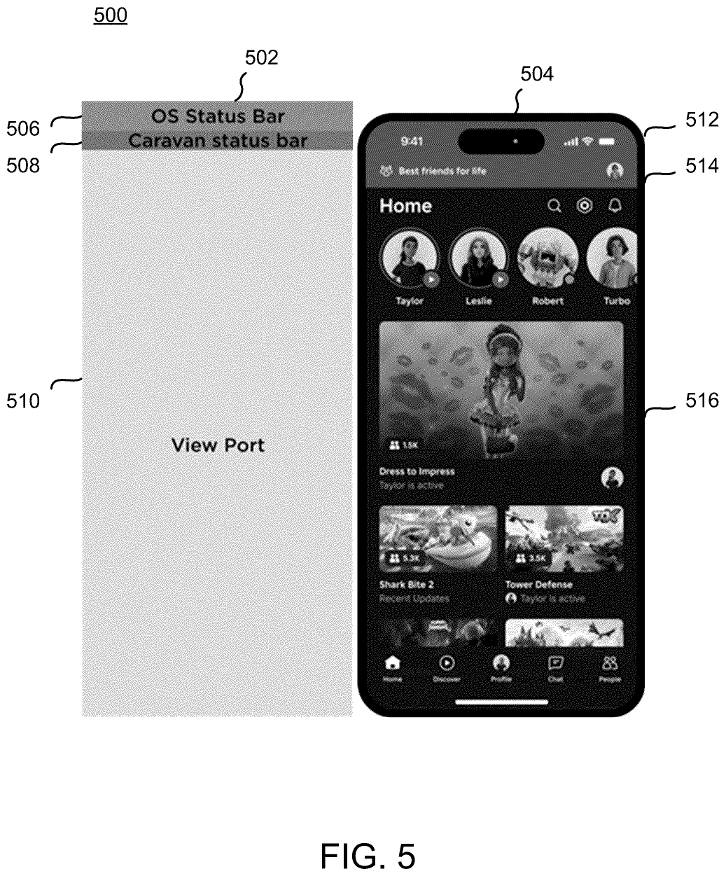

FIG. 5 is a diagram illustrating an example 500 of a user interface for party-based engagement on a platform, in accordance with some implementations. The example includes two parts: a layout diagram 502 illustrating the structure of the user interface, and a diagram 504 of how this structure is applied in a user-facing interface.

In the first part (the layout diagram 502), the layout diagram 502 represents a general user interface framework, highlighting some example elements. At the top of the interface is the OS status bar 506, which displays system-level information such as a time, a battery level, and network connectivity information. The OS status bar 506 may convey this information through text, numbers, graphics, or a combination thereof.

Below the OS status bar 506 is the party status bar 508, also referred to as the caravan status bar 508. This section of the interface provides ongoing updates related to the user's party-based engagement. The party status bar 508 remains persistent as the party persists, permitting users to see the status of the party or group regardless of which activity or screen users are currently viewing on the platform. The main area of the interface is the view port 510, where the content provided by the virtual experience platform, such as user activity, games, and other features, is displayed. The view port 510 may provide, for example, a first virtual experience in which the user participates followed by a second virtual experience in which the user participates.

The second part (the diagram 504) illustrates an example of this layout applied within the platform's home screen. At the top of the screen, the OS status bar 512 displays system information (e.g., time, battery, and phone/network signal). Directly below the OS status bar 512, the party status bar 514 is visible, illustrating the user's active party titled “Best friends for life.” Below the party status bar 514 is the primary content area, or view port 516, which displays the platform's home screen with various games and activities. The user's friends are illustrated at the top of the screen of the view port 516 in the form of avatars, with activity indicators below user names.

Additionally, game recommendations and recently updated experiences are visible within the view port 516, such as dress to impress, shark bite 2, and tower defense.

Presenting this information in the view port 516 enables users to quickly engage with content while remaining aware of a party's ongoing status. Under some of the virtual experiences, an indication that one of the party members is active appears (for example, “Taylor is active” is displayed along with dress to impress and along with tower defense), thus alerting the user to the presence of one or more party members within a specific virtual experience.

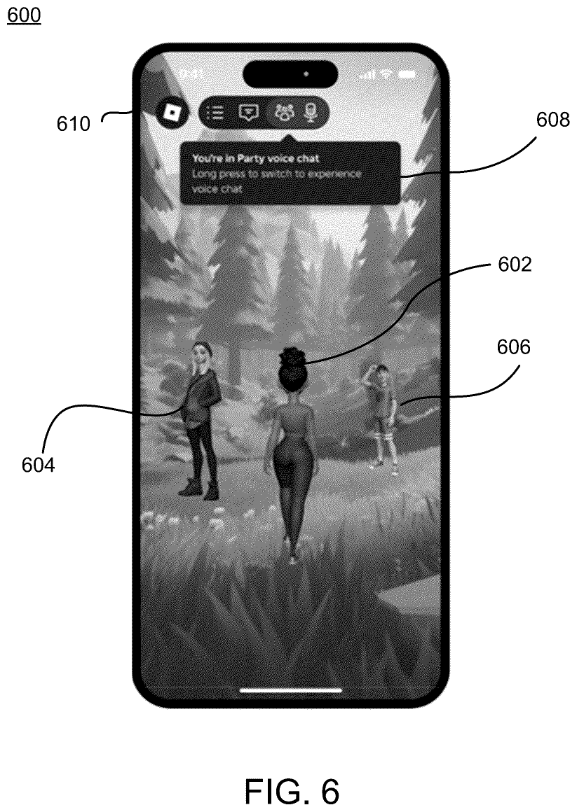

FIG. 6 is a diagram illustrating an example 600 of party-based collaborative engagement within a virtual experience, in accordance with some implementations. In this figure, users are illustrated inside a shared virtual experience. The shared virtual experience illustrates various avatars for the users participating as a party in the shared virtual experience. The users may actively engage with each other and the virtual experience while participating in a “party voice chat.” The virtual environment illustrated in FIG. 6 is an outdoor setting, in which party members interact with one another. The central character 602, controlled by the user, is an avatar navigating through the experience. Avatars corresponding to two other party members are also illustrated on-screen. For example, these avatars may be additional avatar 604 and additional avatar 606. The group is part of a collaborative experience, working or interacting together in the given virtual experience within the virtual environment.

At the top of the screen, a notification banner 608 appears, stating, “You're in Party voice chat.” This message in the notification banner 608 informs the user that the user is currently in voice communication with other users in the user's party, permitting real-time (or near real-time) collaboration and communication within the game (or other virtual experience).

The notification banner 608 may also provide instructions, such as by stating, “Long press to switch to experience voice chat.” This instruction indicates that pressing the notification banner 608 for a fixed interval of time (for example, one to five seconds) gives the user the option to switch from the private party voice chat to the in-experience voice chat. The private party voice chat may be heard by participants in the party, but not by other users. In the in-experience voice chat, a given user may potentially communicate with other users in the virtual world outside of the party. For example, the given user may communicate with users outside of the party, either in a given virtual experience or across virtual experiences.

The interface 610 at the top of the screen includes various control buttons that permit the user to manage interactions with the virtual experience and/or the platform. These controls may include options such as the option to access the platform menu, party settings, and notifications, which may be accessed while remaining within the virtual environment. Despite being immersed in the virtual world, the user can stay connected to the party through the voice chat feature, ensuring seamless communication and coordination without interrupting the gaming experience. Party voice means that a user might be communicating with party members not in the virtual experience but in a different virtual experience.

FIG. 7 is a flowchart illustrating aspects of a method 700 of forming a party of users in a first virtual experience and transitioning the party to a second virtual experience, in accordance with some implementations. Method 700 may begin at block 702.

At block 702, individual users in a group of two or more users are caused to join a first virtual experience on a virtual experience platform. For example, causing the users to join the first virtual experience may include forming communication sessions between client devices of the individual users and the server (or servers) that hosts the instance of the first virtual experience. While the instance of the first virtual experience may be hosted by a single server, it may be noted that a given instance of a virtual experience may also be hosted by a plurality of servers. The users in the group of users are hosted in the same instance of the first virtual experience because this approach makes it more feasible to coordinate changing virtual experience and ensure seamless communication for a party. Block 702 may be followed by block 704.

At block 704, a party connection is formed using a party connection management data structure that may be maintained by the virtual environment. The party connection management data structure may store various information about the users in the party. For example, the party connection management data structure may include a unique party ID (such as a string uniquely identifying a party), and a party member data, which may take the form of a dictionary or another related data structure.

Such a dictionary data structure may include, for each user in the party, a user identifier, a place identifier (corresponding to a server place hosting the user), a job identifier (a unique identifier of the server instance associated with the user), a private server identifier (private server ID provided when a user is in a private/reserved server or a VIP server), and/or a reserved server access code, which may be a string provided when the party member is in a reserved server.

The party connection management data structure may also include a party data array, which includes a dictionary as described above for the users in the party. Such an array may be fetched by an appropriate method as defined by the virtual environment. There may also be a party data map, which maps a previous version of the party data to a newer version of the party data. A purpose of the party data map is to show a developer all the users for a given party that are in a given experience. The party data map coordinates player information across different servers as long as the players are in a party together. Such information may be updated as the party data is updated.

Thus, the party connection management data structure may include various information about individual party members, such as names, identifiers, locations, device information, etc. Block 704 may be followed by block 706.

At block 706, users are provided with a first interface to permit interaction. Such a first interface corresponds to the first virtual experience. Examples of the first interface are shown and previously described above with respect to at least some of FIGS. 3-6. The first interface may be provided through a device through which the users access the first virtual experience. Such access may occur through a dedicated desktop application, a mobile app, or a website presented by a web browser. Any appropriate device may be used, such as a desktop or laptop personal computer (PC), mobile devices (smartphone, tablet, phablet), and game consoles. For example, such a device may access the virtual environment that hosts the first virtual experience. The client device 110 of FIG. 1 is an example of a device that can provide the first interface to each user. Block 706 may be followed by block 708.

At block 708, a transitioning from a first virtual experience to a second virtual experience occurs. The transitioning includes transitioning from the first virtual experience to the second virtual experience on the virtual experience platform by forming communication sessions between the client devices of the users in the group with a second server that hosts a particular instance of the second virtual experience.

The virtual experience platform hosts multiple instances of the second virtual experience. Maintaining the party connection between the users in the group of users during the transitioning comprises performing the transition to ensure that the users are placed in the particular instance of the second virtual experience.

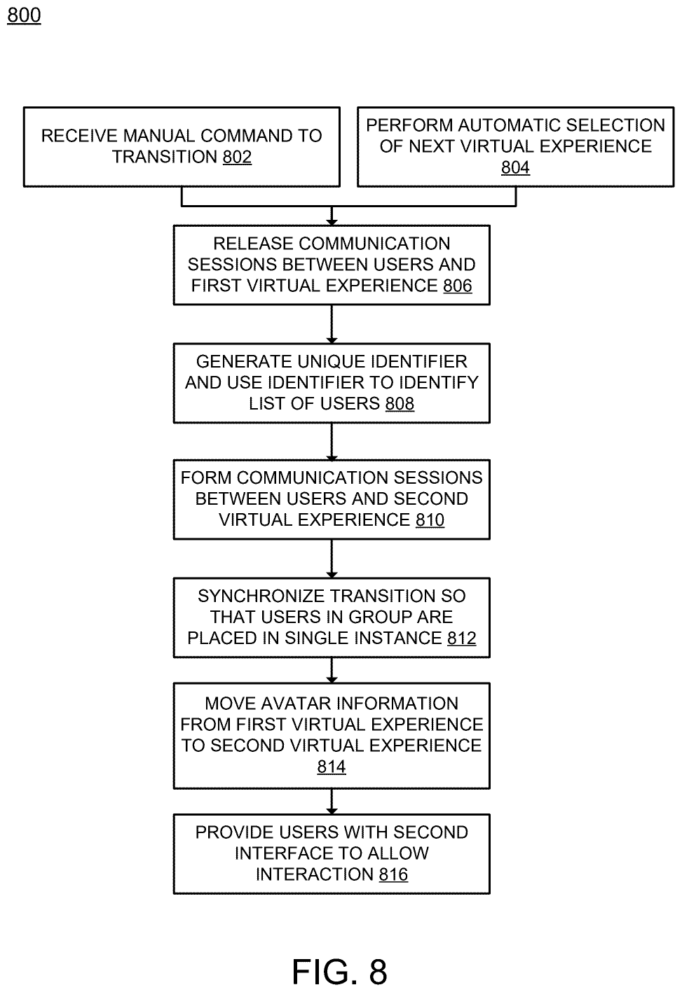

Greater details about such transitioning are presented in FIG. 8. Block 708 may be followed by block 710.

At block 710, users are provided with a second interface to permit interaction. The second interface may be provided through a device through which the users access the second virtual experience. Examples of the second interface are shown and previously described above with respect to at least some of FIGS. 3-6. Such access may occur through a dedicated desktop application, a mobile app, or a website presented by a web browser. Any appropriate device may be used, such as a desktop or laptop personal computer (PC), mobile devices (smartphone, tablet, phablet), and game consoles. For example, such a device may access the virtual environment that hosts the second virtual experience and may be the same or different device used by the user(s) to interact with the first interface in block 706. Such a second interface corresponds to the second virtual experience.

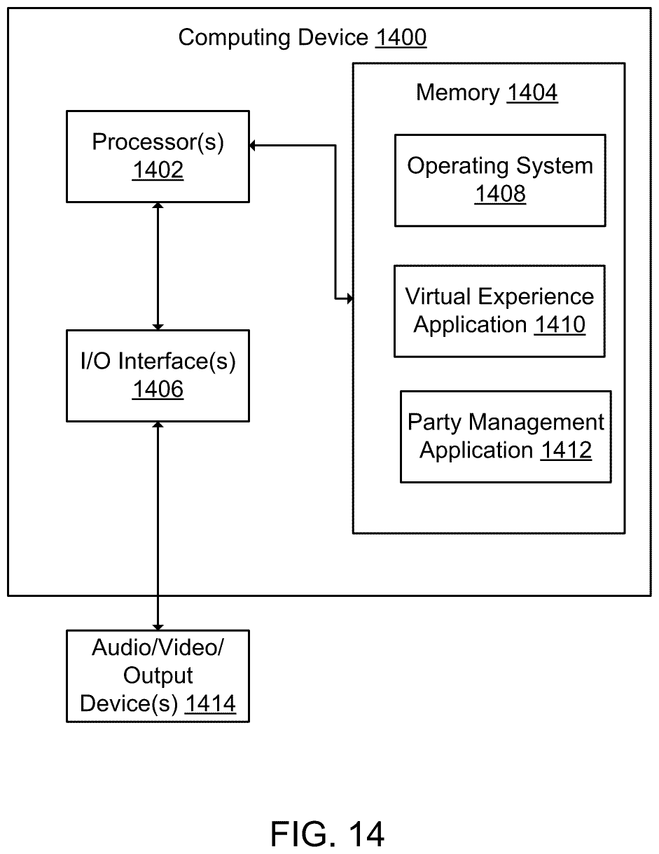

While FIG. 7 illustrates several operations provided in a certain order for carrying out method 700, it may be noted that there may be a variety of modifications to method 700 and/or to any of the other methods described herein. For example, other operations may be added, operations may be omitted, operations may be modified, operations may be combined, operations may be supplemented with other operations, operations may be replaced by other operations, or the order of operations may be varied. For example, the sequence of certain operations may be changed, or some of the operations may be carried out in parallel, as appropriate. Various operations as illustrated in method 700 and/or any other method described herein may be implemented by various hardware and/or software. For example, FIG. 1 and FIG. 14 illustrate various components (such as one or both of the virtual application 112 and the virtual experience engine 104) that may implement the various operations provided in method 700 and/or in any other method described herein, such as by being programmed using various appropriate software to configure the hardware to perform method 700 and/or any other method described herein.

FIG. 8 is a flowchart illustrating aspects of a method 800 of transitioning a party from a first virtual experience to a second virtual experience, in accordance with some implementations. Method 800 may begin at block 802 or block 804.

At block 802, a manual command to initiate a transition is received. For example, the manual command may be received from one or more users in the group of users. The transitioning may be performed in response to at least one user in the group of users providing a command to cause the group of users to join the second virtual experience. There may be various constraints on how a transition may be initiated. For example, a user may be required to have administrator status or other privileges to request such a transition.

Further, once a transition is requested, it may be necessary in some implementations for one or more other users to confirm that the transition is permissible. Also, each of the users may be associated with constraints on the alternative experiences that the users are permitted to participate in (for example, age-based restrictions, location-based restrictions, etc.). In order for the transition to be permitted, all of the users (or a subset of the users) are permitted to participate in the new virtual experience. Because a feature of the party transitioning is to keep the party together, there may be a way provided to change permissions so that users who otherwise may not be permitted to change permissions. It may also be possible to recommend experiences that are suitable for all potential users.

Sometimes the permissions/restrictions cannot be overridden. For example, suppose that a user attempts to initiate a transition to a second virtual experience that is only approved for users 18 and older. For example, if one of the users in the group is 13, that may prevent transferring the group of users to that group until the 13-year-old no longer belongs to the group or the transferring just blocks the 13-year-old. Block 802 may be followed by block 806.

At block 804, an automatic selection of a next virtual experience is received. Such automatic selection of a next virtual experience as the second virtual experience may be based on one or more group preferences, one or more platform recommendations, or other basis or a combination thereof. The transitioning may be based on the automatic selection. Alternatively, a user in the might want to join a different experience and request that the group join that user via an interface.

For example, the actual experience selection may be based on such factors and then occur based on a user instruction. Other factors may lead to an automatic change of experience. For example, a change of experience may occur if a time lapses, or if an electronic currency transaction required for participation to a given virtual experience runs out. Block 804 may be followed by block 806.

At block 806, communication sessions between users and the first virtual experience are released. Such releasing includes sending a signal to the virtual environment that the users are no longer associated with the first virtual experiences. This releasing leads to terminating the connection(s) with the instance of the first virtual experience. Block 806 may be followed by block 808.

At block 808, a unique identifier is generated and used to identify a list of users. Using a unique identifier for the list of users provides a simple and unambiguous way to easily refer to a group of users. For example, as groups are formed, each group may be referred to by an incrementing number (for example, group ID, group number). This approach may involve a central authority (such as a designated entity of the virtual environment that manages assigning identifiers for uniqueness).

Another type of unique identifier may be a universally unique identifier (UUID) or globally unique identifiers (GUIDs). These are 128-bit numbers generated using a standardized technique, designed to be unique across different systems and time, making the identifiers suitable for distributed environments. The unique identifier may also be a composite key, formed by combining multiple attributes or fields from the data structure that, when taken together, form a unique combination.

The identifier may also be produced by hashing or may be other system-generated identifiers. For example, the virtual environment may have built-in capabilities to automatically generate new identifiers for new records or objects. Such a unique identifier may take on different forms. For example, the unique identifier may be a string of numbers, a string of letters, a string of bits, etc. Block 808 may be followed by block 810.

At block 810, communications sessions between users and the second virtual experience are formed. For example, forming such communication sessions may include spinning up an instance of the second virtual experience, and re-connecting users. Spinning up refers to activating the instance. Block 810 may be followed by block 812.

At block 812, the transition is synchronized so that users in the group are placed in a single instance of the second virtual experience. For example, as part of the transition, after block 810, the list of users in the group may be accessed using the unique identifier. It may be verified that, for each user in the list, that the user's connection to the first virtual experience has been terminated and the user's connection to the second virtual experience has been initiated. This operation is done on the server where there is a matchmaking authority that ensures there is space on the server and can even create a new server instance of the experience so that everyone in the party can join. Block 812 may be followed by block 814.

At block 814, avatar information is moved from the first virtual experience to the second virtual experience. The avatar information may be moved by accessing user avatar information from the first virtual experience and then loading that user avatar information. For example, avatar information includes information such as body parts (meshes and textures), rigging armature, face animation data cage meshes, attachments, and user information such as display name, health, movement, player information, or other information.

The users may be associated with preferences that govern the placement of the avatars in the second virtual experience (for example, one user may have preferences that cause the avatar corresponding to that user to be initially placed at a corresponding spawning point or other location, or all avatars may be initially placed at a central spawning point or other location associated with the second virtual experience). Block 814 may be followed by block 816.

At block 816, users are provided with a second interface to permit interaction. At block 816, the users have been consolidated into a group in a single instance of a second virtual experience. Block 816 corresponds to block 710 and involves similar actions. More specifically, each user may access the shared instance. In the shared instance, the users become able to help one another.

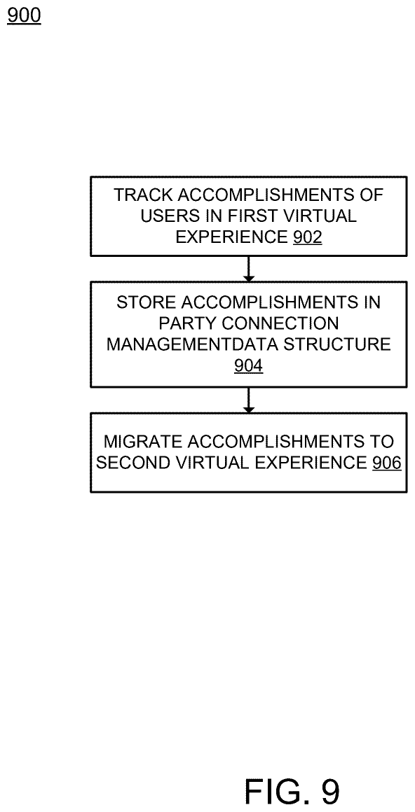

FIG. 9 is a flowchart illustrating aspects of a method 900 of tracking, storing, and migrating user accomplishments from a first virtual experience to a second virtual experience, in accordance with some implementations. Method 900 may begin at block 902.

At block 902, accomplishments of users in the first virtual experience are tracked. For example, the accomplishments may be various in-game accomplishments or in-game effects of the user's actions. For example, the accomplishment may be a level reached or another in-game task that is performed. The accomplishment may also be something that affects the user and/or the avatar corresponding to that user. For example, the accomplishment may include points (e.g., experience points, scoring points, etc.) that may permit the user to reach experience levels or attain a high score.

The accomplishment may also include solving a puzzle, completing a quest, or beating a boss. The accomplishment may also include earning some sort of in-game reward. For example, the accomplishment may be obtaining an item, a skin or costume, a title, an emote, a profile, or an amount of in-game currency. These are only examples, and other accomplishments may be tracked. Block 902 may be followed by block 904.

At block 904, information about the accomplishments is stored in the party connection management data structure. For example, the information about the accomplishments may be stored in a data table or another data structure that stores various accomplishment values for a given user (for example, experience points, hit points, level, Boolean variables that indicated whether given accomplishments have been accomplished, etc.). Such a data structure may be managed by the virtual platform. Block 904 may be followed by block 906.

At block 906, the accomplishments are migrated to the second virtual experience. For example, the second virtual experience may process the data structure to see which accomplishments are relevant to the second virtual experience, and which are not. For example, a user's experience level or number of hit points may be transitioned from a first virtual experience to a second virtual experience. A quest completed in a first virtual experience may not have a great deal of relevance in the context of the second virtual experience and may not be transferred.

The migration may also include making a record of accomplishments for the first virtual experience and maintaining that record if the group returns to the first virtual experience. The migration may also include migrating accomplishments for the entire group of users or for a subset of users, rather than individual users. For example, the entire group of users may have completed a game level, or a subset of the group may have collaborated to achieve a high score.

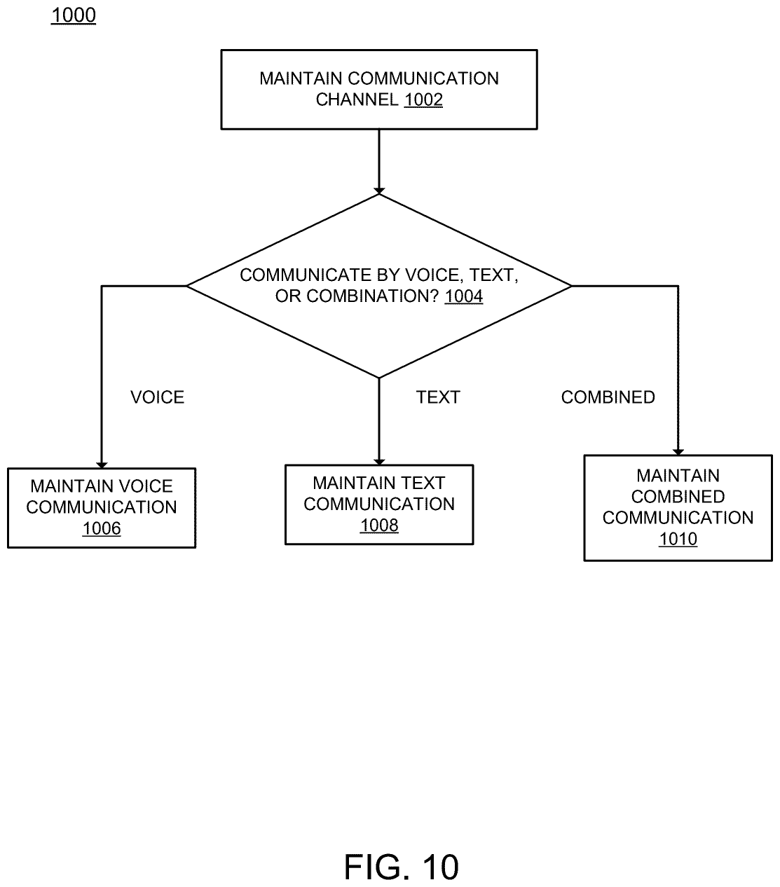

FIG. 10 is a flowchart illustrating aspects of a method 1000 of maintaining a communication channel, in accordance with some implementations. Method 1000 may begin at block 1002.

At block 1002, the communication channel is maintained. Such maintaining occurs as the private communication channel, which was originally hosted to connect the group of users in the first virtual experience, connects the group of users in the second virtual experience. For example, there may be a method to get a list of players using the unique party identifier.

For example, the method may loop through players or get party data mapped to the party. Other methods to aid in this process may include ways to update party data and an event may permit users to connect a callback based on a party identifier, old party data, and/or current party data. There may also be a method used internally to update the party data. Block 1002 may be followed by block 1004.

As another example of a technique to coordinate communication between members of a party, there may be a real-time notification system to coordinate the communication. Such a real-time notification system may be provided by the virtual environment. Such a notification system may be built on web sockets.

In some implementations, the notification system does not permit two way communication. In such implementations, a server does a fire and forget with communication material. In computer science, “fire and forget” refers to a programming pattern where a task is initiated, and the initiating process continues without waiting for the task to complete or for a response. This pattern is often used for asynchronous operations, such as sending messages to a message queue, where the main process does not have to know if the operation was successful. This approach avoids blocking, though the server does not receive feedback on the outcome of the task.

The client receives the message as long as the client has established a connection with the server. Accordingly, there is to be some sort of method to persist party data as otherwise a connection may not be established and it may be difficult to get the data. As discussed, this can be accomplished by using and persisting a party connection management data structure by the virtual environment. The data structure includes the relevant information to manage the party. Also, the data structure can be accessed and updated.

At block 1004, it is determined whether the communication occurs via a voice chat, a text chat, or a combined form of chat. If the chat is a voice chat, block 1004 is followed by block 1006. If the chat is a text chat, block 1004 is followed by block 1008. If the chat is a combined chat, block 1004 is followed by block 1010.

At block 1006, voice communication is maintained. In such implementations, the party connection management data structure is associated with voice communication. For example, the party members may share a voice channel. There may be several ways to transition the voice channel. One approach is to continue the voice channel associated with the first virtual experience until the transition is ready, then activate a voice channel associated with the second virtual experience as quickly as possible.

This situation may leave a gap in communication. There are other approaches to solve the possible gap in communication. For example, there may be an indicator provided to the users that the communication is temporarily suspended while the transition is occurring. Another approach may be to continue using the voice channel from the first virtual experience until the second virtual experience is ready to take over. Another approach may be to use a temporary voice channel to ensure communication continuity until the second virtual experience is ready. Yet another approach may be to use a buffer to synchronize the transition.

At block 1008, text communication is maintained. Text communication may be maintained in various ways similar to maintaining voice communication. Because text communication uses less bandwidth than voice communication, it may be easier to take steps to transition from one text chat to another. For example, simply logging any text messages that may be dropped during the transition may solve these issues.

At block 1010, combined communication is maintained. For example, the combined communication may include a communication approach in which both voice and text are provided to permit the users in the group of users to interact. Similar approaches to those discussed with respect to block 1008 and block 1010 apply. If multiple types of communication are available, this may provide a way to manage transitioning. For example, if there is going to be a gap in voice communication coverage due to the transition, users may be notified of this issue and be permitted to communicate via text while the voice channel is being transitioned.

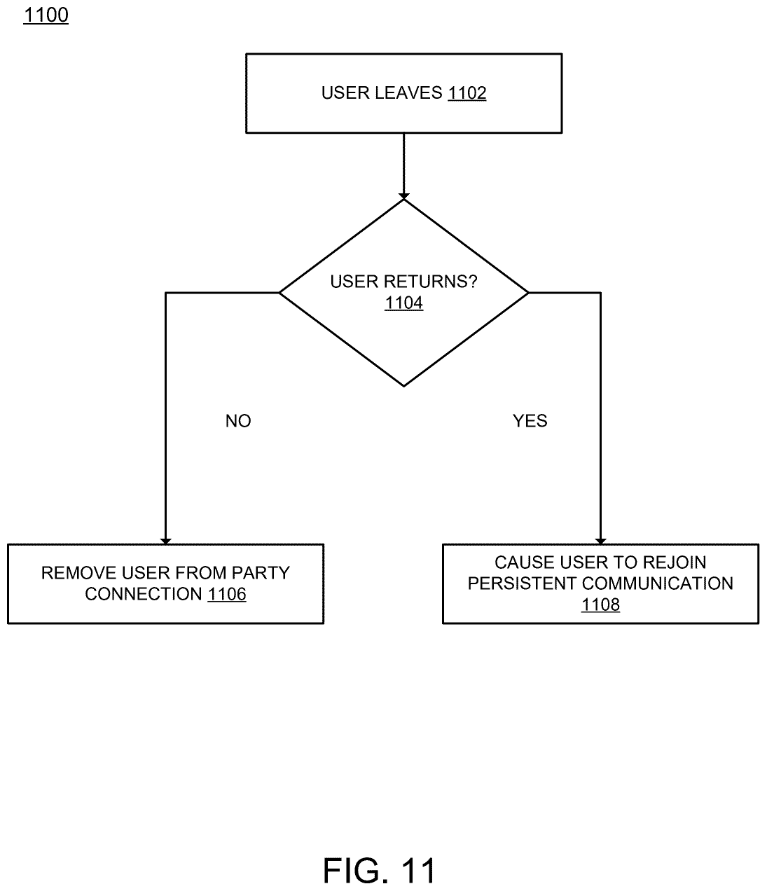

FIG. 11 is a flowchart illustrating aspects of a method 1100 of permitting a user to leave and rejoin a group, in accordance with some implementations. Method 1100 may begin at block 1102.

At block 1102, a user leaves the group. For example, the user may request to leave the group. A user may be also caused to leave the group for other reasons, such as a time limit expiring, insufficient funds, non-compliant behavior, removal by an administrator, etc. Even if a user departs, that user's personal information may be persisted in the party connection management data structure. Such personal information corresponding to the departing user may be kept by the virtual platform until a data storage limit is reached, until a time elapses, until an administrator purges it, etc. Block 1102 may be followed by block 1104.

At block 1104, it is determined whether the user returns. For example, when adding a user to a party, it may be checked to see if information for the user is available. If not, block 1104 is followed by block 1106 and removes the user from the party. If so, block 1104 is followed by block 1108 to help the user rejoin the party.

At block 1106, the user is removed from the party connection. Block 1106 may occur after a certain time-out occurs. For example, the user may be given a set time period (for example, five minutes, ten minutes, etc.) to rejoin the group before the user is removed from the party connection or one of the other conditions discussed above that lead to removing the user's information has occurred. For example, some implementations may check to see if a user was part of the group in the past and see if there is a history that indicates that the user is to be permitted to rejoin the group.

At block 1108, the user is caused to rejoin the persistent communication channel for the group. For example, the party connection management data structure indicates that the user was a member of the party in the past, and the users are not barred from rejoining the party. In addition to such information, the user may require another authorization step for the rejoining to occur (for example, the user may need to be admitted by an administrator).

There may also be a check to see if anything has changed (such as a user property or status) for the user that would influence whether the user is to be admitted to the party. For example, if a user was being admitted to any experience because the user is in the U.S., if the user moves to the UK, re-admitting the user may not be appropriate. Likewise, if a user was excluded from an experience because the user was 12 years old, it may be appropriate to admit the user when the user turns 13. When the user rejoins the persistent communication channel, the user may be admitted into the ongoing communication session.

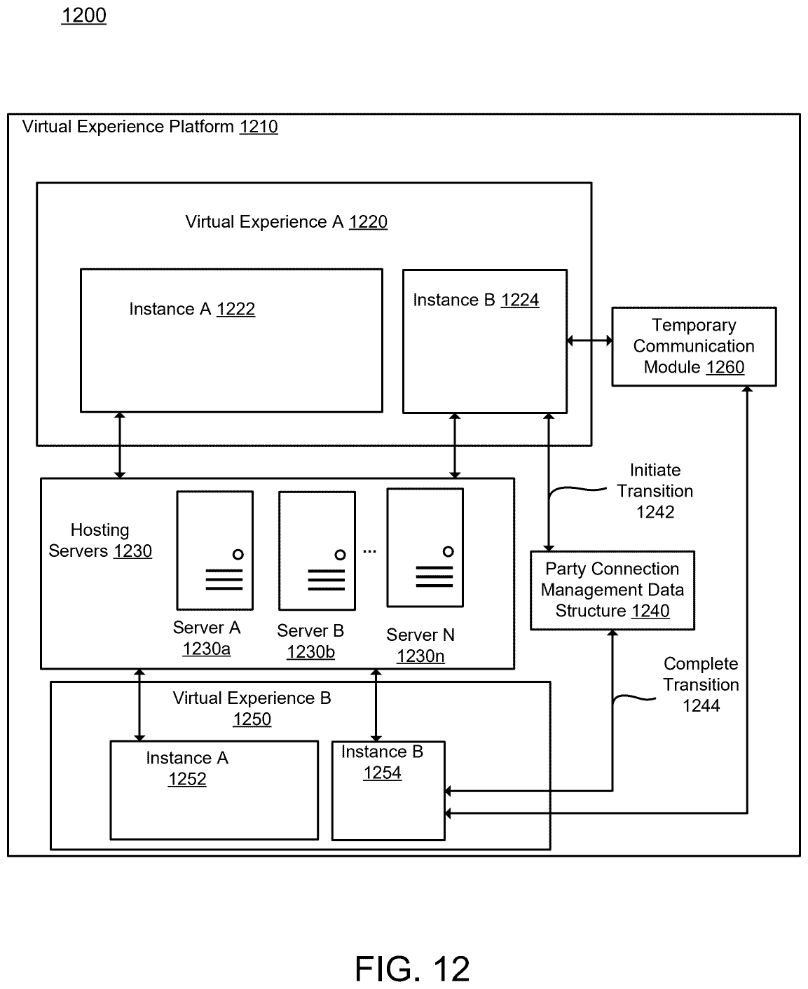

FIG. 12 is a diagram 1200 illustrating an example virtual experience platform hosting instances of virtual experiences at corresponding server(s) and transitioning between virtual experiences, in accordance with some implementations.

FIG. 12 illustrates the structure of a virtual experience platform 1210 (also known as a virtual experience environment 1210). FIG. 12 illustrates that virtual experience platform 1210 hosts a virtual experience A 1220 and a virtual experience B 1250. These are merely examples of virtual experiences, and virtual experience platform 1210 may also host additional virtual experiences (not shown).

Virtual experience A 1220 includes instance A 1222 and instance B 1224. Virtual experience B 1250 includes instance A 1252 and instance B 1254, as examples of instances. Virtual experience platform 1210 may also include N (where N is a natural numbers) hosting servers 1230, such as server A 1230a, server B 1230b, up to server N 1230n. In some implementations, virtual experience platform 1210 may include one server (for example, server A 1230a). For example, the servers 1230 may be the servers 102 of FIG. 1. The virtual experiences 1220 and 1250 may be the virtual experiences 106 of FIG. 1, etc.

Each instance of each virtual experience may be hosted by one or more of the hosting servers 1230. For example, instance A 1222 may be hosted by server A 1230a, and instance B may be hosted by server B 1230b and server N 1230. Likewise, corresponding instances of virtual experience A 1220 and virtual experience B 1250 may be hosted by the same server(s), some of the same server(s), or wholly different servers.

For example, instance A 1222 and instance A 1252 may be hosted by the same server (server A 1230a), instance B 1224 and instance B 1254 may be hosted by the same servers (for example, instance B 1224 and instance B 1254 may be hosted by server B 1230b and server N 1230) or by some of the same servers (for example, instance B 1224 may be hosted by server A 1230a and server B 1230b, while instance B 1254 is hosted by server A 1230a and server N 1230n).

Instance A 1222 of virtual experience A 1220 may be associated with a party connection management data structure 1240. The party connection management data structure 1240 may be comprised of a data structure that stores and manages information for members of the party, as described further above. The party connection management data structure 1240 also helps with transitioning members of the party as a unified group. For example, the party may initially be a group of users interacting with one another in virtual experience A 1220. In order to coordinate the interactions between users in the group of users, the users may all participate in a same instance of virtual experience A 1220, instance A 1222.

Then, the users in the group may be transferred to a corresponding single instance of another virtual experience, such as virtual experience B 1250. The corresponding single instance of virtual experience B 1250 may be instance A 1252. By re-assembling the users in the new instance, it is possible to re-form the group in the new virtual experience.

For example, FIG. 12 illustrates that a party may be associated with a party connection management data structure 1240. When the instance transaction (as discussed herein) begins, such as due to an automatic and/or manual trigger, an initiate transition operation 1242 occurs. The virtual experience platform 1210 accesses the party connection management data structure 1240 and uses the party connection management data structure 1240 to perform a complete transition operation 1244.

Another aspect of transitioning the users in the group is that, even during the transitioning process, a feature is to facilitate any communications to remain seamless. For example, there may be a time interval (albeit brief) when the connections have been shut down for the first virtual experience A 1220, but virtual experience B 1250 is not yet fully capable of providing the connection capabilities.

This issue may be managed in several ways. One way is to maintain the connection between the group of users in the first virtual experience simultaneously with the connection between the group of users in the second virtual experience until it is confirmed that the transition is complete. If users communicate during the transition process, the first virtual experience may handle the communication until the first virtual experience receives an acknowledgment from the second virtual experience that the second virtual experience is ready to take over communication.

For example, virtual experience platform 1210 may host many instances of each virtual experience on different servers. When a group of users join a virtual experience on the virtual experience platform 1210 or a group of forms of users that sequentially join at the same server, the experience is hosted on a first server (or group of servers) and client devices of the users communicate with the first server to collaboratively interact. For example, there may be three users (Alice, Bob, and Carl) that join a first virtual experience hosted by a first server or group of servers.

When the group decides to move to a different virtual experience, the group is transitioned into an instance of the different virtual experience (which may be a newly launched, non-preexisting) instance of the virtual experience. The instance may be on the same first server or a different game server. This is dynamic, based on server workloads and other factors.

Alice, Bob, and Carl migrate to the same instance of the second virtual experience so that the collaboration/chat continues seamlessly. For example, collaboration may provide users in the party an opportunity to play together in a virtual experience. This is non-trivial and is addressed by the party technology presented in implementations herein.

Another approach to managing a seamless transition is to use a separate module included in the virtual experience platform 1210, such as temporary communication module 1260. Temporary communication module 1260 may maintain communication between users in the party in various ways. For example, if the private party communication is achieved using a private voice channel, the first virtual experience may send a signal, such as a handshake or a handoff signal, coordinating the voice communication with the temporary communication module 1260. However, the use of a temporary communication module 1260 is optional, and in some implementations there is no handoff used for private voice communication.

After the receipt of the signal by the temporary communication module 1260, audio sent to the private voice channel may be routed to the temporary communication module 1260 and then re-routed to the individual users. Other forms of communication may be managed, as appropriate, by the temporary communication module 1260. For example, the temporary communication module may intercept text messages and forward the text messages to members of the party while the transition occurs.

It may be noted that certain aspects of the communication may not be readily preserved from transitioning. For example, certain forms of in-game communication are limited to the experiences. It may be possible to capture the content of this communication, regardless.

For example, if a user asked another user which way it is to a street and was responded to by an avatar with a gesture, it would be difficult to preserve the nature of the gesture between experiences. It may be possible to interpret and preserve this content by analyzing the content (for example, using a machine learning (ML) model trained to summarize the content as text/audio). For example, the ML model may summarize the gesture as text, audio, or both saying, “Go Right, Then Left. ”

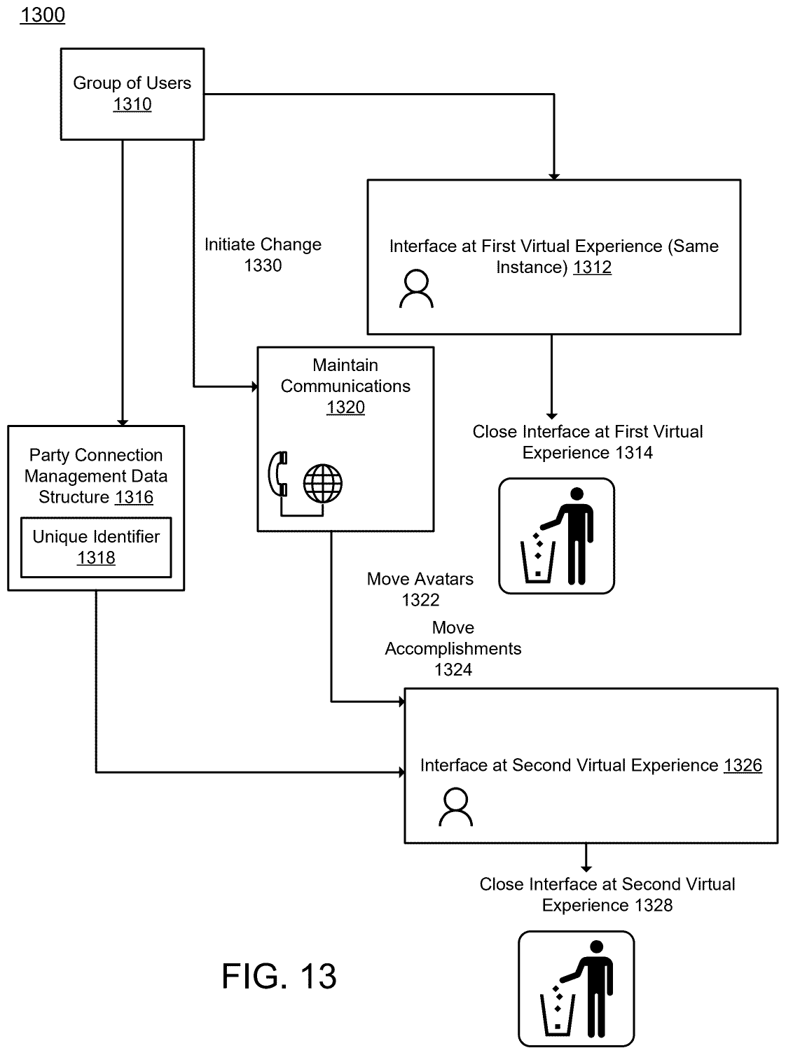

FIG. 13 is a diagram 1300 illustrating aspects of formation of a party and transitioning the party from a first virtual experience to a second virtual experience, in accordance with some implementations.

FIG. 13 begins with a group of users 1310. Such a group of users generally involves at least two users. For example, the group of users may also be referred to as a party of users, as discussed elsewhere herein. There is no upper bound on the number of users in the group except for that dictated by computing resources. It may also be possible to have a group of users 1310 with a single user as a member.

The capabilities set forth herein to coordinate transitions and provide seamless communications generally involve the context of a group of users 1310 with multiple members. If there is one user in the group, a capability of the group is to permit that user to permit other users to join the group. For example, the group may permit that single user to send out invitations to expand the size of the group.

There may be other ways to expand the size of the group. For example, suppose a user in a group is in the same experience as another user. In addition to having users being invited to join the group, it may be possible to notify other users in the experience of the existence of the group. These additional users may request to add the group, which may be an automatically granted request, or a request granted by suitable user(s) who may have appropriate permissions/privileges to approve the requests.

The group of users 1310 may be paired with an interface at a first virtual experience 1312. This interface (e.g., such as those shown in at least some of FIGS. 3-6) is provided in a single instance of the virtual experience. As discussed, having the group of users 1310 participate in the same instance of the first virtual experience facilitates communication between the users in the group and also facilitates moving the group of users 1310 to a second virtual experience as a single unit.

Each user in the group of users 1310 may have access to the interface at the first virtual experience 1312. As described, in the first virtual experience, the users in the group of users 1310 may interact with one another, such as via a voice communication session, a text communication session, or a combination thereof. The users in the group of users 1310 may also interact by controlling corresponding avatars, such that the avatars may communicate by gestures or by manipulating the first virtual experience.

The group of users 1310 may be associated with a party connection management data structure 1316. The information in the party connection management data structure 1316 has already been discussed above. FIG. 13 illustrates that party connection management data structure 1316 is associated with a unique identifier 1318. Aspects of unique identifier 1318 are also discussed above. The party connection management data structure 1316 provides information for use by operation 1320 (maintain communications), which occurs in response to the initiate change operation 1330.

At some point, an initiate change operation 1330 is triggered, either through a manual request, an automatic request, or a combination thereof. The initiate change operation 1330 leads to a transition for the group of users 1310 from the first virtual experience to a second virtual experience. As discussed, the initiate change operation 1330 may involve an approval to occur, and the change of experience happens after this approval occurs.

The transition may be technically challenging (not all users may form connections with a second server at the same time, users are communicating via voice chat and do not want to be interrupted, and the servers may have quality of service (QoS) criteria). Such QoS criteria may include latency to different client devices of the group, overall ability to serve the workload generated by the group joining the second virtual experience, etc.

The initiate change operation 1330 causes several things to happen. First, a maintain communications operation 1320 is initiated. This maintain communications operation 1320 corresponds to similar portions of method 800 as illustrated in FIG. 8. For example, maintaining communications operation 1320 may cause an operation 1314 that releases an interface for users at the first virtual experience. As discussed herein, operation 1314 may be timed in coordination with other operations such that the communications session (whether text, voice, a combination, or another form of communications session) is maintained.

As part of maintain communications operation 1320, there may be a move avatars operation 1322 and a move accomplishments operation 1324. For example, move avatars operation 1322 may correspond to block 814, as presented as part of method 800 in FIG. 8. Move accomplishments operation 1324 may correspond to method 900 in FIG. 9 and may similarly involve accessing accomplishments corresponding to one or more users in group of users 1310. Such operations coordinate transitioning avatar and accomplishment information when transitioning experiences.

FIG. 13 also illustrates that when transitioning the group of users 1310 from the interface at the first virtual experience 1312, the group of users is then hosted using an interface at a second virtual experience at operation 1326. The interaction continues as long as it is appropriate (that is, until the second virtual experience shuts down). At that point, an operation 1328 to close the interface at the second virtual experience occurs.

While FIG. 13 presents a diagram illustrating how groups of users may navigate from interfacing in a first virtual experience to interfacing in a second virtual experience, followed by closing out the second virtual experience, the group of users may make additional transitions. For example, accessing the second virtual experience by the group of users may be followed by transitioning the group of users to a third virtual experience, or by transitioning the group of users back to the first virtual experience.

The virtual platform may also track and persist information from virtual experiences as the experiences are closed, in case the virtual experiences are resumed. For example, at operation 1314, where an interface is closed at a first virtual experience, state information for the first virtual experience may be stored in case the first virtual experience is returned to later. Additionally, part of the maintain communications operation 1320 and other synchronizing facilitates the first virtual experience being updated in case a user returns to the first virtual experience.

Due to storage requirements and other computing resource constraints, the information for previously used virtual experiences may be automatically deleted after a time period elapses or based on a priority associated with the virtual experiences.

The implementations presented herein provide a number of technical advantages. By managing users in a party using a specialized data structure and by providing relevant infrastructure, the technical ability of a computer to transition members in a group or party of users from one virtual experience to another is facilitated. The implementations also provide ways to improve the ability of a virtual platform to maintain communication between users in a party as these transitions occur. The implementations can also transition appropriate information from one experience to another, while also maintaining information in a way that improves the ability of implementations to resume previous virtual experiences effectively.

FIG. 14 is a block diagram that illustrates an example computing device 1400 which may be used to implement one or more features described herein, in accordance with some implementations. In one example, computing device 1400 may be used to implement a computer device (e.g., server 102 and/or client device 110 of FIG. 1), and perform appropriate method implementations described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1400 includes a processor 1402, a memory 1404, input/output (I/O) interfaces 1406, and audio/video input/output devices 1414. At least some of the various components of FIG. 14 as described herein may correspond to analogous components in FIG. 1 (e.g., the I/O interface 1406 and the I/O interface 114/134, the virtual experience application 1410 and the virtual experience application 112/132, etc.).

Processor 1402 can be one or more processors and/or processing circuits to execute program code and control basic operations of the computing device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in computing device 1400 for access by the processor 1402, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1402 and/or integrated therewith. Memory 1404 can store software operating on the computing device 1400 by the processor 1402, including an operating system 1408, a virtual experience application 1410, a party management application 1412, and other applications (not shown). In some implementations, virtual experience application 1410 and/or party management application 1412 can include instructions that enable processor 1402 to perform the functions (or control performance of the functions) described herein (e.g., some or all of the operations of the methods described with respect to FIGS. 7-11).

For example, virtual experience application 1410 can include a party management application 1412, which as described herein can manage party involvement within an online virtual experience server (e.g., server 102). Elements of software in memory 1404 can alternatively be stored on any other suitable storage location or computer-readable medium. In addition, memory 1404 (and/or other connected storage device(s)) can store instructions and data used in the features described herein. Memory 1404 and any other type of storage (magnetic disk, optical disk, magnetic tape, or other tangible media) can be considered “storage” or “storage devices.” I/O interface(s) 1406 can provide functions to enable interfacing the computing device 1400 with other systems and devices. For example, network communication devices, storage devices (e.g., memory and/or data store 120), and input/output devices can communicate via I/O interface(s) 1406. In some implementations, the I/O interface(s) 1406 can connect to interface devices including input devices (keyboard, pointing device, touchscreen, microphone, camera, scanner, etc.) and/or output devices (display device, speaker devices, printer, motor, etc.).

The audio/video input/output devices 1414 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 14 shows one block for each of processor 1402, memory 1404, I/O interface(s) 1406, and software blocks of operating system 1408, virtual experience application 1410, and party management application 1412. These blocks may represent one or more processors or processing circuitries, operating systems, memories, I/O interfaces, applications, and/or software engines. In other implementations, computing device 1400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 1400 (e.g., processor(s) 1402, memory 1404, and I/O interface(s) 1406). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1414, for example, can be connected to (or included in) the computing device 1400 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein (e.g., methods 700, 800, 900, 1000, and 1100) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to enable synchronous party-based interaction across multiple virtual experiences, each virtual experience corresponding to an instance hosted by a server on a virtual experience platform, the computer-implemented method comprising:
causing individual users in a group of two or more users to join a first virtual experience on the virtual experience platform by forming communication sessions between client devices of the individual users with a first server on the virtual experience platform that hosts a first instance of the first virtual experience;
forming a party connection between the users in the group in the first virtual experience by using a party connection management data structure;
providing the users in the group with a first interface that enables the users to collaboratively interact in the first virtual experience via the party connection; and
transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience,
wherein the virtual experience platform hosts multiple instances of the second virtual experience and wherein maintaining the party connection between the users in the group during transitioning comprises performing the transition so that the users are placed in the particular instance of the second virtual experience.

2. The computer-implemented method of claim 1, wherein transitioning further comprises moving user avatar information associated with the individual users in the group from the first instance of the first virtual experience to the particular instance of the second virtual experience.

3. The computer-implemented method of claim 1, wherein forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

4. The computer-implemented method of claim 1, wherein transitioning is performed in response to at least one user in the group providing a command to cause the group to join the second virtual experience.

5. The computer-implemented method of claim 1, further comprising:
tracking accomplishments of the users in the group in the first virtual experience;
storing the accomplishments in the party connection management data structure; and
migrating the accomplishments of the users in the group into the second virtual experience by using the party connection management data structure during transitioning.

6. The computer-implemented method of claim 1, further comprising maintaining a communication channel to provide seamless and continuous communication among the users in the group during collaborative interaction of the users in the first instance of the first virtual experience and during collaborative interaction of the users in the particular instance of the second virtual experience.

7. The computer-implemented method of claim 6, wherein the seamless and continuous communication persists upon one or more individual users of the group leaving one of the first instance of the first virtual experience or the particular instance of the second virtual experience and rejoining the group in the first or the second virtual experience.

8. The computer-implemented method of claim 6, wherein the seamless and continuous communication among the users in the group includes voice communication using a voice communication channel that persists throughout transitioning from the first virtual experience to the second virtual experience.

9. The computer-implemented method of claim 6, wherein the seamless and continuous communication among the users in the group includes text-based communication using a text communication channel that persists throughout transitioning from the first virtual experience to the second virtual experience.

10. The computer-implemented method of claim 1, further comprising:
performing automatic selection of a next virtual experience as the second virtual experience based on one or more group preferences, one or more platform recommendations, or a combination thereof, wherein transitioning is initiated based on the automatic selection.

11. The computer-implemented method of claim 1, wherein the second server that hosts the particular instance of the second virtual experience is same as the first server that hosts the first instance of the first virtual experience.

12. A non-transitory computer-readable medium with instructions stored thereon that, responsive to execution by a processing device, causes the processing device to perform or control performance of operations to enable synchronous party-based interaction across multiple virtual experiences, each virtual experience corresponding to an instance hosted by a server on a virtual experience platform, the operations comprising:
causing individual users in a group of two or more users to join a first virtual experience on the virtual experience platform by forming communication sessions between client devices of the individual users with a first server on the virtual experience platform that hosts a first instance of the first virtual experience;
forming a party connection between the users in the group in the first virtual experience by using a party connection management data structure;
providing the users in the group with a first interface that enables the users to collaboratively interact in the first virtual experience via the party connection; and
transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience,
wherein the virtual experience platform hosts multiple instances of the second virtual experience and wherein maintaining the party connection between the users in the group during transitioning comprises performing the transition so that the users are placed in the particular instance of the second virtual experience.

13. The non-transitory computer-readable medium of claim 12, wherein transitioning further comprises moving user avatar information associated with the individual users in the group from the first instance of the first virtual experience to the particular instance of the second virtual experience.

14. The non-transitory computer-readable medium of claim 12, wherein forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

15. The non-transitory computer-readable medium of claim 12, wherein transitioning is performed in response to at least one user in the group providing a command to cause the group to join the second virtual experience.

16. The non-transitory computer-readable medium of claim 12, the operations further comprising maintaining a communication channel to provide seamless and continuous communication among the users in the group during collaborative interaction of the users in the first instance of the first virtual experience and during collaborative interaction of the users in the particular instance of the second virtual experience.

17. A system comprising:
a memory with instructions stored thereon; and
a processing device, coupled to the memory, the processing device configured to access the memory and execute the instructions, wherein the instructions cause the processing device to perform or control performance of operations to enable synchronous party-based interaction across multiple virtual experiences, each virtual experience corresponding to an instance hosted by a server on a virtual experience platform, the operations comprising:
causing individual users in a group of two or more users to join a first virtual experience on the virtual experience platform by forming communication sessions between client devices of the individual users with a first server on the virtual experience platform that hosts a first instance of the first virtual experience;
forming a party connection between the users in the group in the first virtual experience by using a party connection management data structure;
providing the users in the group with a first interface that enables the users to collaboratively interact in the first virtual experience via the party connection; and
transitioning from the first virtual experience to a second virtual experience on the virtual experience platform by using the party connection management data structure to maintain the party connection by forming communication sessions between the client devices of the users in the group with a second server on the virtual experience platform that hosts a particular instance of the second virtual experience,
wherein the virtual experience platform hosts multiple instances of the second virtual experience and wherein maintaining the party connection between the users in the group during transitioning comprises performing the transition so that the users are placed in the particular instance of the second virtual experience.

18. The system of claim 17, wherein transitioning further comprises moving user avatar information associated with the individual users in the group from the first instance of the first virtual experience to the particular instance of the second virtual experience.

19. The system of claim 17, wherein forming the party connection between the users in the group comprises generating a list of users in the group, wherein the list is associated with a unique identifier on the virtual experience platform, and wherein transitioning uses the unique identifier to access the list of users to identify all of the users in the group to transition each user from the first instance of the first virtual experience to the particular instance of the second virtual experience.

20. The system of claim 17, wherein the operations further comprise maintaining a communication channel to provide seamless and continuous communication among the users in the group during collaborative interaction of the users in the first instance of the first virtual experience and during collaborative interaction of the users in the particular instance of the second virtual experience.
